(19) United States
(12) Patent Application Publication
(10) Pub. No.: US 2009/0309481 A1
(43) Pub. Date: Dec. 17, 2009

(54) Field emission device and method for fabricating cathode emitter and zinc oxide anode

(75) Inventors: Yu-Hsien CHOU, Dasi Township (TW); Yuh SUNG, Dasi Township (TW); Ming-Der GER, Dasi Township (TW); Yih-Ming LIU, Dasi Township (TW); Chun-Wei KUO, Dasi Township (TW); Jun-Yu YEH, Dasi Township (TW); Yun-Chih FAN, Dasi Township (TW)

Correspondence Address: BACON & THOMAS, PLLC, 625 SLATERS LANE, FOURTH FLOOR, ALEXANDRIA, VA, 22314-1176, US

(73) Assignee: National Defense University, Bade City (TW)

(21) Appl. No.: 12/379,266

(22) Filed: Feb. 18, 2009

(30) Foreign Application Priority Data
Jun. 17, 2008 (TW) 097122589

(51) Int. Cl. H01J 1/62; C23C 22/83

(52) U.S. Cl. 313/483; 205/194; 148/276; 977/742; 977/750; 977/752

(57) ABSTRACT

The present invention relates to methods for fabricating a cathode emitter and a zinc oxide anode for a field emission device to improve the adhesion between emitters and a substrate and enhance the luminous efficiency of a zinc oxide thin film so that the disclosed methods can be applied in displays and lamps. In comparison to a conventional method for fabricating a field emission device, the method according to the present invention can reduce the cost and time for manufacture and is suitable for fabricating big-sized products. In addition, the present invention further discloses a field emission device comprising a zinc oxide/nano carbon material cathode, a zinc oxide anode and a spacer.

### BACKGROUND OF THE INVENTION

1. Field of the Invention

The present invention relates to a field emission device and a method for manufacturing a cathode emitter and a zinc oxide anode and, more particularly, to a field emission device and a method of manufacturing a cathode emitter and a zinc oxide anode for improving the emission intensity and uniformity.

2. Description of Related Art

In 1928, R. H. Fowler and L. W. Nordheim first provided a field emission theory as follows. When a high voltage is applied between two conductors, electrons located on the cathode surface and in the vacuum are of a reduced potential energy while the barrier thickness of the potential energy decreases. In other words, when the voltage is extremely high, potential barrier thickness is small. Therefore, the electrons do not necessarily have potential energy higher than the potential barrier, and they can directly cross the potential barrier, enter the vacuum and be emitted from the cathode surface. The above-mentioned is the mechanism of the field emission. A basic structure of a field emission device substantially is composed of an anode plate (phosphor plate), a cathode plate (tip base plate), and a spacer. A vacuum (<10⁻⁵˜10⁻⁶ torr) exists between the two plates. The anode plated is an indium tin oxide glass substrate on which phosphor powders are applied, and the cathode plate is composed of field emitter arrays.

In 1968, C. A. Spindt first suggested a field emission device used in a light, i.e. a cathode plate composed of field emitter arrays, in which electron sources are spike-shaped and mainly made of Mo, is formed on a glass substrate. However, since the size of such structures is limited to the level of microlithography for forming openings on the substrate and to the vapor deposition for producing metal spikes, the size of light is dramatically restricted. Besides, the tips of spindt-type field emitters are easily damaged whereby they have a short lifespan.

Currently, field emission display devices focus on carbon nanotube field emission display devices (CNT-FED). Carbon nanotubes (CNTs) were discovered by Professor Iijima in 1991. Generally, CNTs have excellent conductivity and a large aspect ratio of length to diameter in geometry, therefore possessing good abilities of field emission. In this regard, researchers incorporate CNTs into a display device to develop cathode plates of CNT-FEDs or field emission backlight units.

The present techniques performed in cathode plates of CNT-FEDs or field emission backlight units are screen-printing, chemical vapor deposition (CVD), electroplating, electrophoresis, and electroless plating etc. However, these methods respectively have some problems.

CVD has advantages such as directly depositing uniform CNTs on a substrate, depositing well-aligned CNTs, and depositing CNTs in a predetermined area by assistance of a previously coated patterned catalyst. However, the CVD involves complex procedures and expensive equipment in the purpose of depositing CNTs with good field-emission ability. Furthermore, the deposition temperature is generally higher than the glass transition temperature of the substrate (Tg, about 550° C.) and CNTs have poor adhesion on the glass substrate, short lifespan, and there is difficulty in controlling quality of a single CNT. Hence, CNTs are only at the stage of research, and rarely applied in the industry.

At present, screen-printing is a mainstream technique potentially applied in large-scaled devices in the industry. In the screen-printing, a mixture of an organic solvent, glass powders, silver paste, and CNTs is applied on a substrate, and then cured at high temperature for removing the unnecessary organic solvent. Hence, the screen-printing has simple procedures, and no limitation in the scale of the size, and its cost is lower than a CVD. However, defects such as poor adhesion between CNTs and the substrate, great consumption of CNTs, a need to remove the organic solvent, CNT damage during baking, irregularity of emitters, poor uniformity of luminance etc. are bottlenecks in the screen-printing.

Electrophoresis is changing the surface electric property of CNTs, aggregating the CNTs on the electrode by charge, and then baking the CNTs. Although this method can improve the defect of CNT inconsistency in the screen-printing and economize on the cost, the adhesion between the CNTs and the substrate is still poor and the thickness of deposited CNTs is not uniform enough. Hence, the lifespan and illuminating uniformity of the field emission sources still needs to be advanced.

Electroplating is a simple and economical method. In the electroplating, dispersed CNTs are put into an electrolytic bath, and deposited together with reduced metal on the cathode surface. Although this method can improve the adhesion between the CNTs and the substrate, irregularity of current density occurs easily during electroplating thereby negatively influencing uniformity of the CNTs in the deposited metal, resulting in irregularity of field emitters and poor uniformity of luminance.

Electroless plating is a simple method involving cheap equipment, and can be applied in a large area. In the electroless plating, CNTs and reduced metal are deposited on the substrate surface to become a CNT-metal composite film for improvement of the adhesion between the CNTs and the substrate. The obtained field emitters distribute evenly so as to efficiently promote the illuminating uniformity. However, the electroless plating solution is an unstable system, and its life is short. If the solution incurs over-high pH value or local overheating, or has some impurities (for example, CNTs) during the electroless plating, some tiny catalytic substances may be produced and this leads to uncontrollable performance of intense autocatalysis in the solution, leading to a decayed solution of the electroless plating.

Therefore, there is a need to find a method meeting the demands of low costs, simple procedures, being applied in a large scale, good adhesion between the CNTs and the substrate, long lifespan of field emission sources, and desirable uniformity of luminance among the current techniques.

In addition, phosphor powders have been applied in illuminators and display devices for half a century. There are various kinds of phosphor powders, and they are substantially classified into organic phosphor powders, phosphor pigments, inorganic phosphor powders, radioelements and so forth. Nowadays, development of the anode plate in a display device trends towards phosphor materials with high efficiency at a low voltage, thin films of phosphor materials, and large-scaled manufacturing. Up to the present, zinc oxide is a most highlighted material among developing low-voltage phosphor materials, and it can emit phosphor light (blue green light) at 10-1000V. Besides, such phosphor light is far brighter than others are, and thus is especially suitable for application in monochrome display devices.

Referring to methods for manufacturing phosphor films made of zinc oxide, there are sol-gel processes, metal organic chemical vapor deposition (MOCVD), molecular beam epitaxy (MBE), pulsed laser deposition (PLD), RF or DC magnetron sputtering, ion beam enhanced deposition (IBED), electron beam evaporation, thermal oxidation, electroless plating, and so on. Among these methods, some are performed at an over-high temperature which limits the substrate materials (such as glass substrate), and some need expensive costs and equipment thereby being unsuitable for large-scaled and mass production. Electroless plating can directly deposit zinc oxide film, and can satisfy the above-mentioned demands such as low manufacturing temperature, low costs, thin films, and mass production. However, the quality of the zinc oxide film obtained by electroless plating is poorer than that obtained by the others. Hence, there is a need to develop a technique of depositing zinc oxide film with low costs, high quality, small thickness and mass production.

### SUMMARY OF THE INVENTION

The object of the present invention is to provide a field emission device and a method for manufacturing a cathode emitter and a zinc oxide anode, which improve the adhesion between the substrate and the emitters, promote illuminating efficiency of zinc oxide film, and satisfy the demands of low costs, simple procedures, large-scaled, mass production, and increasing the lifespan of field emission sources.

To achieve the object, the present invention provides a method for manufacturing a cathode emitter of a field emission device, which includes: (a) immersing a substrate in a zinc solution, and depositing a zinc-plating layer on the substrate by an electrochemical method; (b) placing the substrate deposited with the zinc-plating layer in a chemical conversion coating bath to oxidize the zinc-plating layer into a zinc oxide film under a chemical conversion coating reaction; (c) immersing the substrate formed with the zinc oxide film in a surface-modified carbon nanomaterial aqueous solution which provides a plurality of surface-modified carbon nanomaterials of which one end is adhered onto the zinc oxide film; and (d) baking the zinc oxide film. Accordingly, the cathode emitter made of the zinc oxide/carbon nanomaterial composite can be obtained in the present invention.

In the above-mentioned method, the substrate can be surface-treated, such as degreased or roughened, preliminarily to improve both surface cleanness and roughness before the substrate is immersed in the zinc solution.

In the above-mentioned method, the zinc solution and the chemical conversion coating bath exhibit a uniform distribution of flow field, and thus the zinc-plating layer and the zinc oxide film both having even thickness can be formed in order on the substrate under electrochemical reactions.

In the above-mentioned method, the chemical conversion coating reaction is preferably performed at 20˜80° C. Besides, the zinc oxide film is preferably baked at 100˜350° C.

In the above-mentioned method, the electrochemical method can be electroplating or electroless plating. In addition, the zinc solution can be a zinc electroplating solution or a zinc electroless plating solution. Actually, the zinc electroplating or electroless plating solutions are not limited as long as the -zinc-plating layer can be formed by electroplating or electroless plating. For example, the zinc electroplating solution 9000 Series produced by Jasco® C.o. Japan is used. The zinc electroless plating solution, which is homemade, can comprise zinc sulfate, ethylenediamine tetraacetic acid, citric acid, nitrilotriacetic acid, titanium chloride, a pH regulator, and a solvent.

In the above-mentioned method, the chemical conversion coating bath is not limited as long as it can react on the zinc-plating layer to form the zinc oxide film. Preferably, the chemical conversion coating bath comprises Cr³⁺, oxalic acid, sodium nitrate, PO₂³⁻, Co²⁺, a pH regulator, and a solvent.

In the above-mentioned method, the surface-modified carbon nanomaterial aqueous solution can comprise the plurality of carbon nanomaterials, a nonionic surfactant, an anionic surfactant, and water. The carbon nanomaterials can be any conventional carbon nanomaterial, for example single-walled carbon nanotubes, double-walled carbon nanotubes, few-walled carbon nanotubes, multi-walled carbon nanotubes, carbon nanofibers, spiral carbon nanofibers, nanodiamonds, or the combination thereof. The anionic surfactant can be any conventional anionic surfactant, for example sodium octyl sulfate, sodium dodecyl sulfate, sodium dodecyl benzene sulfonate, dodecylbenzene sulfonate, or the combination thereof. The nonionic surfactant can be any conventional nonionic surfactant, for example polyethylene glycol (PEG), CO-890, Triton® X-100. Accordingly, the carbon nanomaterials can be dispersed by a sonicator, purified, and surface-modified so that the surfaces of the carbon nanomaterials can have negative charge to make them uniform dispersedness in the aqueous solution.

In the above-mentioned method, since the temperature of the process is not at high, the substrate is unlimited, and it can be metal substrates (such as metal plate made of iron, cobalt, nickel, stainless steel, or low carbon steel; metal network; or metal wires) glass substrates or indium tin oxide (ITO) glass substrates.

In conclusion, the principle for manufacturing the cathode emitters made of the zinc oxide/carbon nanomaterial composite in the present invention is as follows. Since the conductive film of zinc oxide becomes sol-gel when film formation, it has good adsorption to the surface-modified carbon nanomaterials having negative charge. After the surface-modified carbon nanomaterials (evenly dispersed) are adsorbed onto the zinc oxide film, the film having pore arrays can transform into a compact film by dehydration under baking at a high temperature. According to this principle, while the zinc oxide film transforms from sol-gel into solid, one end of the surface-modified carbon nanomaterials adsorbed in the pores is embedded into the zinc oxide film owing to film fixation, and then the obtained cathode emitters made of the zinc oxide/carbon nanomaterial composite can have good adhesion and uniformity.

Furthermore, the present invention provides a method for manufacturing a zinc oxide anode for a field emission device, comprising: (a) immersing a substrate into a zinc solution, and depositing a zinc-plating layer on the substrate by an electrochemical method; and (b) oxidizing the zinc-plating layer into a zinc oxide layer by thermal oxidation. Accordingly, the zinc oxide conductive layer, having electroluminescence and high transparency, can be formed on the substrate in the present invention.

In the method mentioned above, the substrate can be surface-treated, such as degreased or roughened, preliminarily to improve surface cleanness and roughness before the substrate is immersed in the zinc solution.

In the method mentioned above, the zinc solution exhibits a uniform distribution of flow field, and thus the zinc-plating layer having uniform thickness can be formed on the substrate under electrochemical reactions.

In the method mentioned above, the thermal oxidation is preferably performed at 5˜100 sccm of oxygen and at 250˜650° C., and the purity of oxygen used therein is preferably 90˜99.99%.

In the method mentioned above, the electrochemical method can be electroplating or electroless plating. In addition, the zinc solution can be a zinc electroplating solution or a zinc electroless plating solution. Actually, the zinc electroplating or electroless plating solutions are not limited as long as the zinc-plating layer can be formed by electroplating or electroless plating. For example, the zinc electroplating solution 9000 Series produced by Jasco® C.o. Japan is used. The zinc electroless plating solution, which is homemade, can comprise zinc sulfate, ethylenediamine tetraacetic acid, citric acid, nitrilotriacetic acid, titanium chloride, a pH regulator, and a solvent.

In the method mentioned above, since the temperature of the process is not at high temperature, the substrate needs no limit, and it can be any conventional substrate. Preferably, the substrate is glass substrates or indium tin oxide (ITO) glass substrates.

Accordingly, the principle for preparing the anode of zinc oxide phosphor materials in the present invention describes as follows. When the zinc-plating layer is thermal-oxidized with oxygen at a high temperature, zinc is reacted with oxygen to transform into an electroluminescent zinc oxide film. Besides, the ratio of zinc to oxygen in the zinc oxide film can be controlled by different concentrations of oxygen so that phosphor materials having various luminescent properties can be obtained.

The foregoing techniques can be applied in a field emission device such as a field emission lamp (straight-, circular- and spiral-shaped), a single-sided flat field emission illuminator, a single-sided flat field emission light, a double-sided light-emitting panel field emission illuminator, or a double-sided light-emitting panel field emission light.

In addition, the present invention further provides a field emission device comprising: a cathode comprising a first substrate, a zinc oxide film coated on the first substrate, and a plurality of surface-modified carbon nanomaterials dispersed on the zinc oxide film, wherein one end of the surface-modified carbon nanomaterials is adhered onto the zinc oxide film; at least one anode comprising a second substrate, and a phosphor material layer coated on the second substrate, wherein the phosphor material layer of the anode faces the surface-modified carbon nanomaterials of the cathode; and at least one spacer between the cathode and the anode to maintain the gap there between.

In the aforesaid field emission device, the phosphor material layer can be a zinc oxide layer which can be prepared by the method for manufacturing the zinc oxide anode mentioned above. Besides, the cathode can be prepared by the above-mentioned method for manufacturing the cathode emitter.

In the aforesaid field emission device, the surface-modified carbon nanomaterials can be obtained by being surface-modified with an anionic surfactant. The surface-modified carbon nanomaterials can be single-walled carbon nanotubes, double-walled carbon nanotubes, few-walled carbon nanotubes, multi-walled carbon nanotubes, carbon nanofibers, spiral carbon nanofibers, nanodiamonds, or the combination thereof.

Other objects, advantages, and novel features of the invention will become more apparent from the following detailed description when taken in conjunction with the accompanying drawings.

### BRIEF DESCRIPTION OF THE DRAWINGS

FIG. 1 shows a fluorescence spectrum of the zinc oxide in Example 7 of the present invention;

FIGS. 2A and 2B are a perspective view of the field emission lamp in Device Example 1, and an enlarged view of its cathode, respectively;

FIGS. 3A and 3B are a perspective view of the field emission illuminator or light in Device Example 2, and an enlarged view of its cathode, respectively;

FIGS. 4A and 4B are a perspective view of the field emission illuminator or light in Device Example 3, and an enlarged view of its cathode, respectively;

FIGS. 4C and 4D are an enlarged view of the patterned cathode of the field emission illuminator or light in Device Example 3, respectively;

FIGS. 5A and 5B are a perspective view of the field emission illuminator or light in Device Example 4, and an enlarged view of its cathode, respectively;

FIGS. 6A and 6B are a perspective view of the field emission illuminator or light in Device Example 5, and an enlarged view of its cathode, respectively; and

FIGS. 6C and 6D are an enlarged view of the patterned cathode of the field emission illuminator or light in Device Example 5, respectively.

### DETAILED DESCRIPTION OF THE PREFERRED EMBODIMENT

The present invention relates to techniques for manufacturing cathode emitters of zinc oxide/carbon nanomaterial composite and anodic zinc oxide phosphor materials, and combines these techniques to be applied in a field emission device.

The zinc oxide/carbon nanomaterial composite cathode emitter is characterized as follows. The substrate is treated in order with the deposition of the zinc-plating layer and the chemical conversion coating so that a zinc oxide film covers the substrate surface. Such zinc oxide film is a conductive semiconductor material, and it has compact micro-pore arrays. Thus, when the substrate is immersed in the surface-modified carbon nanomaterial aqueous solution and then baked, the carbon nanomaterials on the sol-gel zinc oxide film can be embedded therein by closing of those pores at high temperature to promote the adhesion to the zinc oxide film. In addition, the distribution density of the carbon nanomaterials can be controlled, and the uniformity of the film can be advanced. Accordingly, this technique can improve the adhesion between the substrate and the emitters, promote illuminating uniformity, and satisfy the demands of low costs, simple procedures, large-scaled, and increasing the lifespan of field emission sources.

Besides, the anodic zinc oxide phosphor material is characterized as follows. The substrate (glass or ITO glass) is surface-treated preliminarily to improve the cleanness and roughness, and then it is treated with deposition of the zinc-plating layer (electroless plating for a glass substrate; electroplating for an ITO glass). Subsequently, the substrate coated with the zinc-plating layer is treated at a high temperature under the oxygen atmosphere in a muffle furnace. Through the controls of the oxygen flow and the temperature, a conductive film of zinc oxide, having electroluminescence and high transparence, is formed on the substrate. The present invention provides conductive and phosphor materials of zinc oxide having high transmittance by electrochemistry and thermoxidation. Hence, not only can the temperature of the processes decrease to freely use the materials of the substrate, but also the demands of zinc oxide films for low costs, simple procedures, mass production, large-scaled, high quality, and small thickness can be satisfied.

### EXAMPLE 1

### Preparation of Cathode Emitters of Zinc Oxide/Carbon Nanomaterial Composite on a Metal Plate

A substrate (an iron plate) is surface-degreased, and then immersed in a zinc electroplating solution to form a zinc-plating layer deposited thereon by electroplating. The substrate is immersed in a chemical conversion coating bath to oxidize the zinc-plating layer into a zinc oxide film at 40° C. Subsequently, the substrate coated with the zinc oxide film is dipped in a few-walled carbon nanotube aqueous solution, and then it is baked at 150° C. for 5 minutes. The technique of the present example can successfully provide a cathode emitter of zinc oxide/carbon nanomaterial composite having good brightness and uniformity of luminance when a commercial product is used as the anode plate in the field emission device.

In the present example, the chemical zinc solution for depositing the zinc-plating layer is obtained from JASCO®. Japan, and its commercial name is 9000 Series.

In the present example, components of the chemical conversion coating bath for forming the zinc oxide film and the concentrations thereof are listed as the following Table 1.

TABLE 1
The composition of the chemical conversion coating bath (water as
the solvent)

| Component | Concentration of component (M) |
|---|---|
| Cr³⁺ | 0.05~1.5 |
| Oxalic acid | 0.06~2.1 |
| Sodium nitrate | 0.01~0.5 |
| PO₂³⁻ | 0.1~1 |
| CO²⁺ | 0.005~0.2 |
| pH regulator (nitric acid) | pH value |
| | 1~4 |

In the present example, components of the few-walled carbon nanotube aqueous solution and the concentrations thereof are listed as the following Table 2.

TABLE 2
The composition of the few-walled carbon nanotube aqueous
solution

| Component | Concentration of component (g/L) |
|---|---|
| Few-walled carbon | 0.001~1 |
| nanotube | |
| Nonionic surfactant | 0.1~0.6 |
| Anionic surfactant | 0.1~0.6 |

### EXAMPLE 2

### Preparation of Cathode Emitters of Zinc Oxide/Carbon Nanomaterial Composite on a Metal Network

A substrate (a stainless steel network) is surface-degreased, and then immersed in the zinc electroplating solution (It is obtained from JASCO® Japan, and its commercial name is 9000 Series) to form a zinc-plating layer deposited thereon by electroplating. The substrate is immersed in the chemical conversion coating bath (as shown in Table 1) to oxidize the zinc-plating layer into a zinc oxide film at 55° C. Subsequently, the substrate coated with the zinc oxide film is dipped in the few-walled carbon nanotube aqueous solution (as shown in Table 2), and then it is baked at 200° C. for 5 minutes. The technique of the present example can successfully provide a cathode emitter of zinc oxide/carbon nanomaterial composite having good brightness and uniformity of luminance when a commercial product is used as the anode plate in the field emission device.

### EXAMPLE 3

### Preparation of Cathode Emitters of Zinc Oxide/Carbon Nanomaterial Composite on a Metal Wire

A substrate (a nickel wire) is surface-degreased, and then immersed in the zinc electroplating solution (It is obtained from JASCO® Japan, and its commercial name is 9000 Series) to form a zinc-plating layer deposited thereon by electroplating. The substrate is immersed in the chemical conversion coating bath (as shown in Table 1) to oxidize the zinc-plating layer into a zinc oxide film at 65° C. Subsequently, the substrate coated with the zinc oxide film is dipped in the few-walled carbon nanotube aqueous solution (as shown in Table 2), and then it is baked at 300° C. for 5 minutes. The technique of the present example can successfully provide a cathode emitter of zinc oxide/carbon nanomaterial composite having good brightness and uniformity of luminance when a commercial product is used as the anode plate in the field emission device.

### EXAMPLE 4

### Preparation of Cathode Emitters of Zinc Oxide/Carbon Nanomaterial Composite on a Metal Wire

A substrate (an iron wire) is surface-degreased, and then immersed in the zinc electroplating solution (It is obtained from JASCO® Japan, and its commercial name is 9000 Series) to form a zinc-plating layer deposited thereon by electroplating. The substrate is immersed in the chemical conversion coating bath (as shown in Table 1) to oxidize the zinc-plating layer into a zinc oxide film at 30° C. Subsequently, the substrate coated with the zinc oxide film is dipped in a multi-walled carbon nanotube aqueous solution, and then it is baked at 100° C. for 5 minutes. The technique of the present example can successfully provide a cathode emitter of zinc oxide/carbon nanomaterial composite having good brightness and uniformity of luminance when a commercial product is used as the anode plate in the field emission device.

In the present example, the composition of the multi-walled carbon nanotube aqueous solution is listed as the following Table 3.

TABLE 3
The composition of the composition of the multi-walled carbon
nanotube aqueous solution

| Component | Concentration of component (g/L) |
|---|---|
| Multi-walled carbon | 0.002~1.5 |
| nanotube | |
| Nonionic surfactant | 0.1~0.6 |
| Anionic surfactant | 0.1~0.6 |

### EXAMPLE 5

### Preparation of Cathode Emitters of Zinc Oxide/Carbon Nanomaterial Composite on a Glass Substrate

A glass substrate is surface-degreased, and then immersed in a zinc electroless plating solution to form a zinc- plating layer deposited thereon by electroless plating. The substrate is immersed in the chemical conversion coating bath (as shown in Table 1) to oxidize the zinc-plating layer into a zinc oxide film at 80° C. Subsequently, the substrate coated with the zinc oxide film is dipped in a carbon nanofiber aqueous solution, and then it is baked at 350° C. for 5 minutes. The technique of the present example can successfully provide a cathode emitter of zinc oxide/carbon nanomaterial composite having good brightness and uniformity of luminance when a commercial product is used as the anode plate in the field emission device.

In the present example, the compositions of the zinc electroless plating solution and the carbon nanofiber aqueous solution are respectively listed as the following Tables 4 and 5.

TABLE 4
The composition of the zinc electroless plating solution (water as the
solvent)

| Component | Concentration of component (M) |
|---|---|
| Zinc sulfate | 0.04~1.2 |
| Ethylenediamine tetraacetic | 0.03~1 |
| acid | |
| Citric acid | 0.17~0.68 |
| Nitrilotriacetic acid | 0.1~1 |
| Titanium chloride | 0.02~0.08 |
| pH regulator (ammonia) | pH value |
| | 9~11 |

TABLE 5
The composition of the carbon nanofiber aqueous solution

| Component | Concentration of component (g/L) |
|---|---|
| Carbon nanofiber | 0.01~2 |
| Nonionic surfactant | 0.1~0.6 |
| Anionic surfactant | 0.1~0.6 |

### EXAMPLE 6

### Preparation of Cathode Emitters of Zinc Oxide/Carbon Nanomaterial Composite on an ITO Glass Substrate

An ITO glass substrate is surface-degreased, and then immersed in the zinc electroless plating solution (as shown in Table 4) to form a patterned zinc-plating layer deposited thereon by electroless plating. The substrate is immersed in the chemical conversion coating bath (as shown in Table 1) to oxidize the zinc-plating layer into a zinc oxide film at 30° C. Subsequently, the substrate coated with the zinc oxide film is dipped in a single-walled carbon nanotube aqueous solution, and then it is baked at 200° C. for 5 minutes. The technique of the present example can successfully provide a cathode emitter of zinc oxide/carbon nanomaterial composite having good brightness and uniformity of luminance when a commercial product is used as the anode plate in the field emission device.

In the present example, the composition of the single-walled carbon nanotube aqueous solution is listed as the following Table 6.

TABLE 6
The composition of the single-walled carbon nanotube aqueous
solution

| | |
|---|---|
| Component | Concentration of component (g/L) |

| | |
|---|---|
| Single-walled carbon nanotube | 0.001~0.005 |
| Nonionic surfactant | 0.1~0.6 |
| Anionic surfactant | 0.1~0.6 |

### EXAMPLE 7

### Preparation of Cathode Emitters of Zinc Oxide/Carbon Nanomaterial Composite on a Metal Plate

A substrate (an iron plate) is surface-degreased, and then immersed in the zinc electroplating solution (It is obtained from JASCO® Japan, and its commercial name is 9000 Series) to form a patterned zinc-plating layer deposited thereon by electroplating. The substrate is immersed in the chemical conversion coating bath (as shown in Table 1) to oxidize the zinc-plating layer into a zinc oxide film at 40° C. Subsequently, the substrate coated with the zinc oxide film is dipped in a nanodiamond aqueous solution, and then it is baked at 150° C. for 5 minutes. The present example shows that the technique of the present example can successfully provide a cathode emitter of zinc oxide/carbon nanomaterial composite having good brightness and uniformity of luminance.

In the present example, the composition of the nanodiamond aqueous solution is listed as the following Table 7.

TABLE 7
The composition of the nanodiamond aqueous solution

| Component | Concentration of component (g/L) |
|---|---|
| Nanodiamond | 0.001~0.005 |
| Nonionic surfactant | 0.1~0.6 |
| Anionic surfactant | 0.1~0.6 |

### EXAMPLE 8

### Preparation of an Anodic Conductive Phosphor Material of Zinc Oxide, Having High Transmittance, on a Glass Substrate

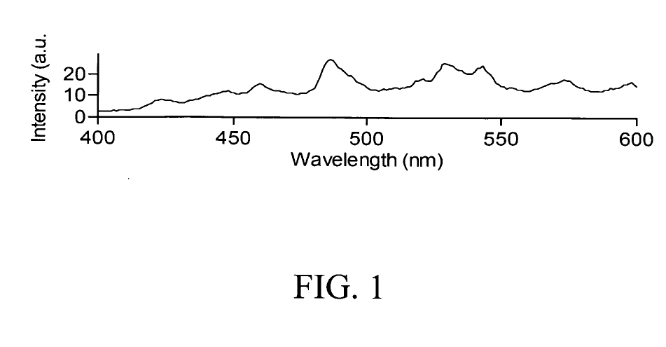

A glass substrate is surface-degreased and roughened, and then immersed in the zinc electroless plating solution (as shown in Table 4) to form a zinc-plating layer deposited thereon by electroless plating. The substrate is annealed in a muffle furnace at 250° C. under the atmosphere of oxygen at 5 or 100 sccm. Using a photoluminescence spectrometer, it is analyzed that the phosphor material of zinc oxide in the present example can emit blue green luminescence at the wavelength of 470˜510 nm as shown in FIG. 1.

### EXAMPLE 9

### Preparation of an Anodic Conductive Phosphor Material of Zinc Oxide, Having High Transmittance, on an ITO Glass Substrate

An ITO glass substrate is surface-degreased, and then immersed in the zinc electroless plating solution (as shown in Table 4) to form a zinc-plating layer deposited thereon by electroless plating. The substrate is annealed in a muffle furnace at 650° C. under the atmosphere of oxygen at 5 or 100 sccm. The phosphor material of zinc oxide in the present example is analyzed by a photoluminescence spectrometer. The result shows that the phosphor material can emit blue green luminescence at the wavelength of 470˜510 nm.

### COMPARATIVE EXAMPLE 1

### Preparation of Cathode Emitters of Zinc Oxide/Carbon Nanomaterial Composite on a Metal Plate

A substrate (an iron plate) is surface-degreased, and then immersed in the zinc electroplating solution (It is obtained from JASCO® Japan, and its commercial name is 9000 Series) to form a zinc-plating layer deposited thereon by electroplating. The substrate is immersed in the chemical conversion coating bath (as shown in Table 1) to oxidize the zinc-plating layer into a zinc oxide film at 25° C. Subsequently, the substrate coated with the zinc oxide film is dipped in the few-walled carbon nanotube aqueous solution (as shown in Table 2), and then it is baked at 200° C. for 5 minutes. The zinc oxide film is not formed well owing to a low reaction rate at the low temperature. It is difficult for CNT to adhere onto the substrate surface, resulting in the deterioration of the luminance uniformity of the field emitter.

### COMPARATIVE EXAMPLE 2

### Preparation of Cathode Emitters of Zinc Oxide/Carbon Nanomaterial Composite on a Metal Network

A substrate (an iron network) is surface-degreased, and then immersed in the zinc electroplating solution (It is obtained from JASCO® Japan, and its commercial name is 9000 Series) to form a zinc-plating layer deposited thereon by electroplating. The substrate is immersed in the chemical conversion coating bath (as shown in Table 1) to oxidize the zinc-plating layer into a zinc oxide film at 85° C. Subsequently, the substrate coated with the zinc oxide film is dipped in the few-walled carbon nanotube aqueous solution (as shown in Table 2), and then it is baked at 200° C. for 5 minutes. After the aforesaid processes all are completed, the status of the carbon nanotubes encompassed by the zinc oxide film in the cathode is observed by a field emission scan electric microscope (FE-SEM). As shown in the result, the adhesion of the zinc oxide film is poor owing to a violent reaction rate at the high temperature. A great amount of the film cracks is lost in the plating solution, resulting in the deterioration of the luminance efficiency of the field emitter.

### COMPARATIVE EXAMPLE 3

### Preparation of Cathode Emitters of Zinc Oxide/Carbon Nanomaterial Composite on a Glass Substrate

A glass substrate is surface-degreased, and then immersed in the zinc electroless plating solution (as shown in Table 4) to form a zinc-plating layer deposited thereon by electroless plating. The substrate is immersed in the chemical conversion coating bath (as shown in Table 1) to oxidize the zinc-plating layer into a zinc oxide film at 55° C. Subsequently, the substrate coated with the zinc oxide film is dipped in the few-walled carbon nanotube aqueous solution (as shown in Table 2), and then it is baked at 90° C. for 5 minutes. The sol-gel zinc oxide film is dehydrated inefficiently because of being at the low baking temperature. The CNTs are insufficiently secured onto the zinc oxide film resulting from incomplete closure of the pores thereon. Hence, the adhesion of the CNTs decreases to degrade the luminance efficiency of the field emitter.

### COMPARATIVE EXAMPLE 4

### Preparation of Cathode Emitters of Zinc Oxide/Carbon Nanomaterial Composite on a Glass Substrate

A glass substrate is surface-degreased, and then immersed in the zinc electroless plating solution (as shown in Table 4) to form a zinc-plating layer deposited thereon by electroless plating. The substrate is immersed in the chemical conversion coating bath (as shown in Table 1) to oxidize the zinc-plating layer into a zinc oxide film at 55° C. Subsequently, the substrate coated with the zinc oxide film is dipped in the few-walled carbon nanotube aqueous solution (as shown in Table 2), and then it is baked at 400° C. for 5 minutes. As shown in the result, the sol-gel zinc oxide film is dehydrated too fast due to being at a high temperature, leading to crack occurrence of the film. Therefore, the cathode emitters are damaged and incapable of field emission.

### COMPARATIVE EXAMPLE 5

### Preparation of an Anodic Conductive Phosphor Material of Zinc Oxide, Having High Transmittance, on an ITO Glass Substrate

An ITO glass substrate is surface-degreased and roughened, and then immersed in the zinc electroless plating solution (as shown in Table 4) to form a zinc-plating layer deposited thereon by electroless plating. The substrate is annealed in a muffle furnace at 150° C. under the atmosphere of oxygen at 5 or 100 sccm. Since the temperature is not high enough, there is no intact zinc oxide film formed. Using a photoluminescence spectrometer to analyze the resultant, the result shows that there is no blue green luminescence at the wavelength of 470˜510 nm.

### COMPARATIVE EXAMPLE 6

### Preparation of an Anodic Conductive Phosphor Material of Zinc Oxide, Having High Transmittance, on a Glass or ITO Glass Substrate

A glass or ITO glass substrate is surface-degreased and roughened, and then immersed in the zinc electroless plating solution (as shown in Table 4) to form a zinc-plating layer deposited thereon by electroless plating. The substrate is annealed in a muffle furnace at 700° C. under the atmosphere of oxygen at 5 or 100 sccm. Using a field emission scan electric microscope (FE-SEM) to analyze the resultant, cracks occur during the formation of the zinc oxide, leading to a significant increase in the film cracking rate.

Tables 8 and 9 show comparisons of cathode emitters of zinc oxide/carbon nanomaterial composite and conductive phosphor materials of zinc oxide respectively between the examples and the comparative examples.

TABLE 8
Cathode emitters of zinc oxide/carbon nanomaterial composite

| | | | | | Luminance |
|---|---|---|---|---|---|
| | | Carbon | Conversion | Baking | of field |
| | Substrate | nanomaterial | temperature | temperature | emission |
| Example 1 | Metal plate | Few-walled | 40° C. | 150° C. | Yes; Good |
| | | carbon | | | uniformity |
| | | nanotubes | | | |
| Example 2 | Metal | Few-walled | 55° C. | 200° C. | Yes; Good |
| | network | carbon | | | uniformity |
| | | nanotubes | | | |
| Example 3 | Metal wire | Few-walled | 65° C. | 300° C. | Yes; Good |
| | | carbon | | | uniformity |
| | | nanotubes | | | |
| Example 4 | Metal wire | Multi-walled | 30° C. | 100° C. | Yes; Good |
| | | carbon | | | uniformity |
| | | nanotubes | | | |
| Example 5 | Glass | Carbon | 80° C. | 350° C. | Yes; Good |
| | | nanofibers | | | uniformity |
| Example 6 | ITO glass | Single-walled | 30° C. | 200° C. | Yes; Good |
| | | carbon | | | uniformity |
| | | nanotubes | | | |
| Example 7 | Metal plate | Nanodiamonds | 40° C. | 150° C. | Yes; Good |
| | | | | | uniformity |
| Comparative | Metal plate | Few-walled | 25° C. | 200° C. | Yes; Poor |
| example 1 | | carbon | | | uniformity |
| | | nanotubes | | | |
| Comparative | Metal | Few-walled | 85° C. | 200° C. | Yes; Poor |
| example 2 | network | carbon | | | uniformity |
| | | nanotubes | | | |
| Comparative | Glass | Few-walled | 55° C. | 90° C. | Yes; Poor |
| example 3 | | carbon | | | uniformity |
| | | nanotubes | | | |
| Comparative | Glass | Few-walled | 55° C. | 400° C. | No |
| example 4 | | carbon | | | |
| | | nanotubes | | | |

TABLE 9
Anodic conductive phosphor materials of zinc oxide

| | | Oxygen | | |
|---|---|---|---|---|
| | | flow | | |
| | Substrate | (sccm) | Tempature | Fluorescence |
| Example 8 | Glass | 5 or 100 | 250° C. | Yes |
| Example 9 | ITO glass | 5 or 100 | 650° C. | Yes |
| Comparative | Glass or ITO | 5 or 100 | 150° C. | No |
| example 5 | glass | | | |
| Comparative | Glass or ITO | 5 or 100 | 700° C. | Film cracks of zinc |
| example 6 | glass | | | oxide dropping |

### DEVICE EXAMPLE 1

### The Field Emission Lamp of Zinc Oxide/Carbon Nanomaterial Composite

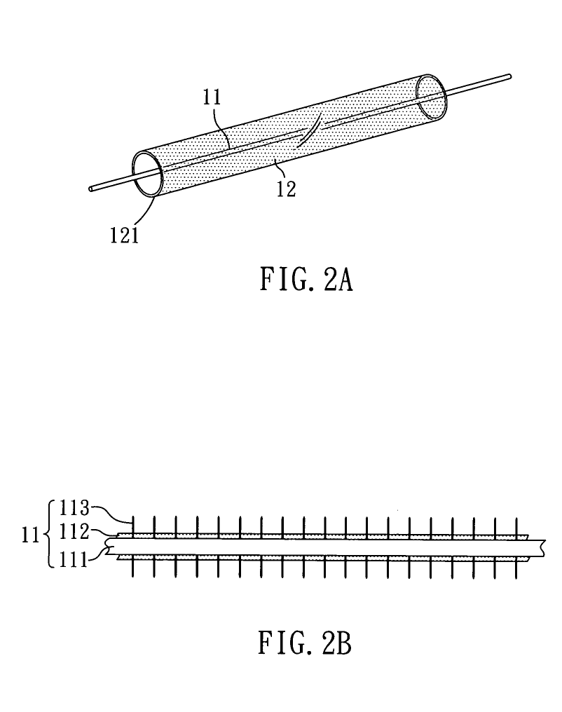

FIGS. 2A and 2B show a perspective view of the field emission lamp in the present example, and an enlarged view of its cathode, respectively. The field emission lamp of the present example mainly contains a cathode 11 comprising a first substrate 111 (metal wire), a zinc oxide film 112 coated on the first substrate 111, and a plurality of surface-modified carbon nanomaterials 113 dispersed on the zinc oxide film 112, wherein one end of the surface-modified carbon nanomaterials 113 is adhered onto the zinc oxide film 112 (FIG. 2B); an anode 12 comprising a second substrate 121 (glass tube), and a phosphor material layer (made of zinc oxide, not shown in the figures) coated on the second substrate 121, wherein the phosphor material layer of the anode 12 faces the surface-modified carbon nanomaterials 113 of the cathode 11; and a spacer (not shown in the figures) disposed between the cathode 11 and the anode 12 to maintain the gap therebetween. The field emission lamp of the present example can emit blue green light having high brightness and good uniformity.

### DEVICE EXAMPLE 2

### The Single-Sided Flat Field Emission Illuminator or Light of Zinc Oxide/Carbon Nanomaterial Composite

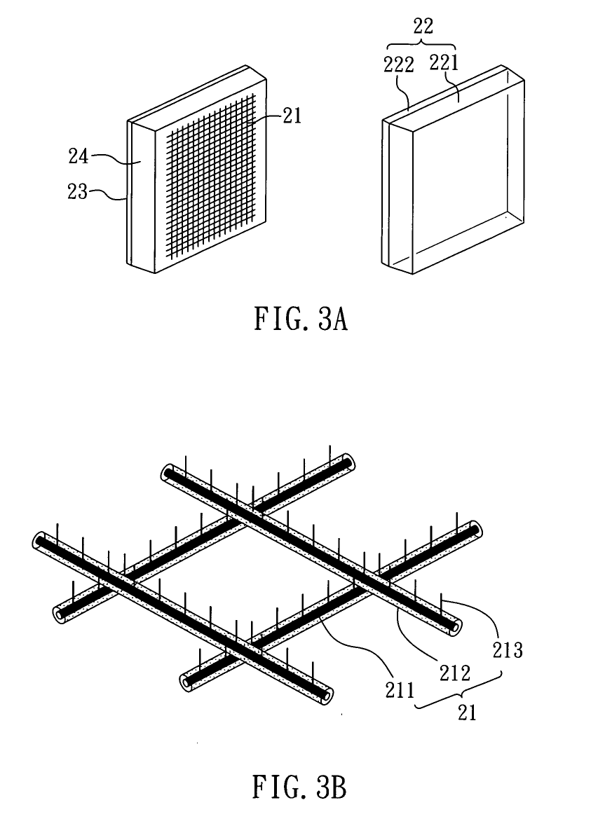

FIGS. 3A and 3B show a perspective view of the field emission lamp in the present example, and an enlarged view of its cathode, respectively. The single-sided flat field emission illuminator or light of the present example contains a reflection plate 23, a glass plate 24, and a cathode 21 in that sequence. The cathode 21 comprises a first substrate 211 (metal network), a zinc oxide film 212 coated on the first substrate 211, and a plurality of surface-modified carbon nanomaterials 213 dispersed on the zinc oxide film 212, wherein one end of the surface-modified carbon nanomaterials 213 is adhered onto the zinc oxide film 212 (FIG. 3B); an anode 22 comprising a second substrate 221 (glass plate), and a phosphor material layer 222 (made of zinc oxide) coated on the second substrate 221, wherein the phosphor material layer 222 of the anode 22 faces the surface-modified carbon nanomaterials 213 of the cathode 21; and a spacer (not shown in the figures) disposed between the cathode 21 and the anode 22 to maintain the gap therebetween. The reflection plate 23 is made of a metal capable of reflecting light. The field emission illuminator or light of the present example can emit blue green light having high brightness and good uniformity.

### DEVICE EXAMPLE 3

### The Single-Sided Panel Field Emission Illuminator or Light of Zinc Oxide/Carbon Nanomaterial Composite

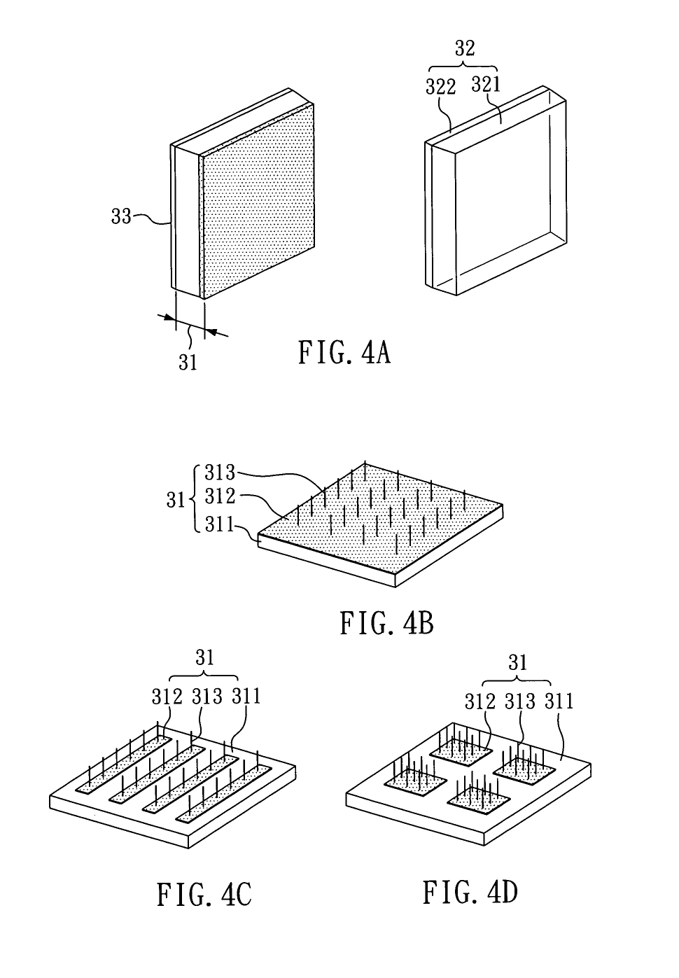

FIGS. 4A and 4B show a perspective view of the field emission lamp in the present example, and an enlarged view of its cathode, respectively. The single-sided panel field emission illuminator or light of the present example mainly contains a reflection plate 33, and a cathode 31 in that sequence. The cathode 31 comprises a first substrate 311 (glass plate), a zinc oxide film 312 coated on the first substrate 311, and a plurality of surface-modified carbon nanomaterials 313 dispersed on the zinc oxide film 312, wherein one end of the surface-modified carbon nanomaterials 313 is adhered onto the zinc oxide film 312 (FIG. 4B); an anode 32 comprising a second substrate 321 (glass plate), and a phosphor material layer 322 (made of zinc oxide) coated on the second substrate 321, wherein the phosphor material layer 322 of the anode 32 faces the surface-modified carbon nanomaterials 313 of the cathode 31; and a spacer (not shown in the figures) disposed between the cathode 31 and the anode 32 to maintain the gap therebetween. The reflection plate 33 is made of a metal capable of reflecting light. The field emission illuminator or display device of the present example can emit blue green light having high brightness and good uniformity.

Besides, the present example also provides an aspect of a patterned cathode. With reference to FIGS. 4C and 4D, the zinc oxide film 312 and the surface-modified carbon nanotubes 313 are formed on the partial surface of the first substrate 311 so as to form a patterned cathode.

### DEVICE EXAMPLE 4

### The Double-Sided Panel Field Emission Illuminator or Light of Zinc Oxide/Carbon Nanomaterial Composite

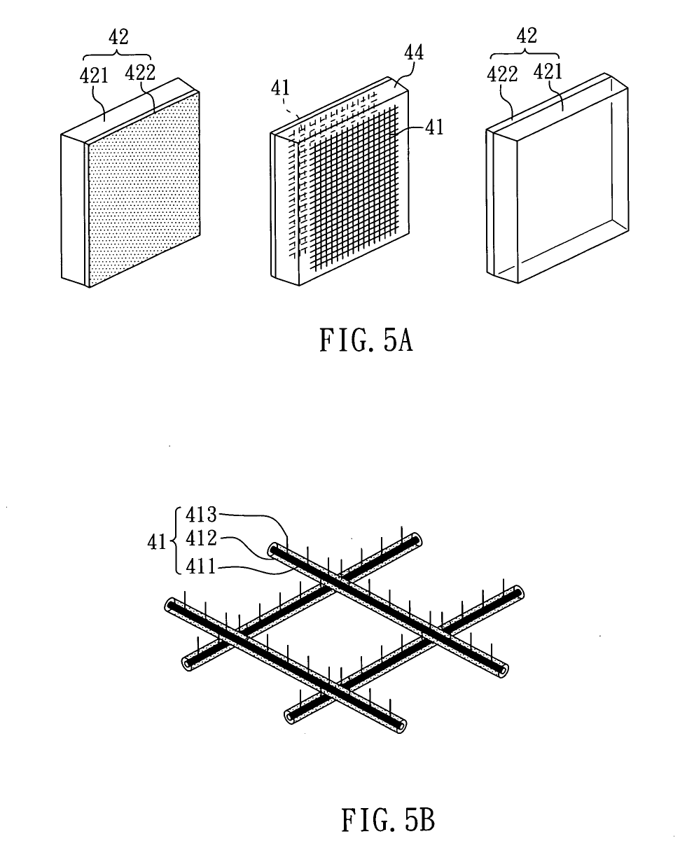

FIGS. 5A and 5B show a perspective view of the field emission lamp in the present example, and an enlarged view of its cathode, respectively. The double-sided panel field emission illuminator or light of the present example mainly contains a glass plate 44; a cathode 41 disposed on the opposite surfaces of the glass plate 44, which comprises a first substrate 411 (metal network), a zinc oxide film 412 coated on the first substrate 411, and a plurality of surface-modified carbon nanomaterials 413 dispersed on the zinc oxide film 412, wherein one end of the surface-modified carbon nanomaterials 413 is adhered onto the zinc oxide film 412 (FIG. 5B); a plurality of anodes 42 comprising a second substrate 421 (glass plate), and a phosphor material layer 422 coated on the second substrate 421, wherein the phosphor material layer 422 of the anodes 42 faces the surface-modified carbon nanomaterials 413 of the cathode 41; and a spacer (not shown in the figures) disposed between the cathode 41 and the anodes 42 to maintain the gap therebetween. The field emission illuminator or light of the present example can emit blue green light having high brightness and good uniformity.

### DEVICE EXAMPLE 5

### The Double-Sided Panel Field Emission Illuminator or Light of Zinc Oxide/Carbon Nanomaterial Composite

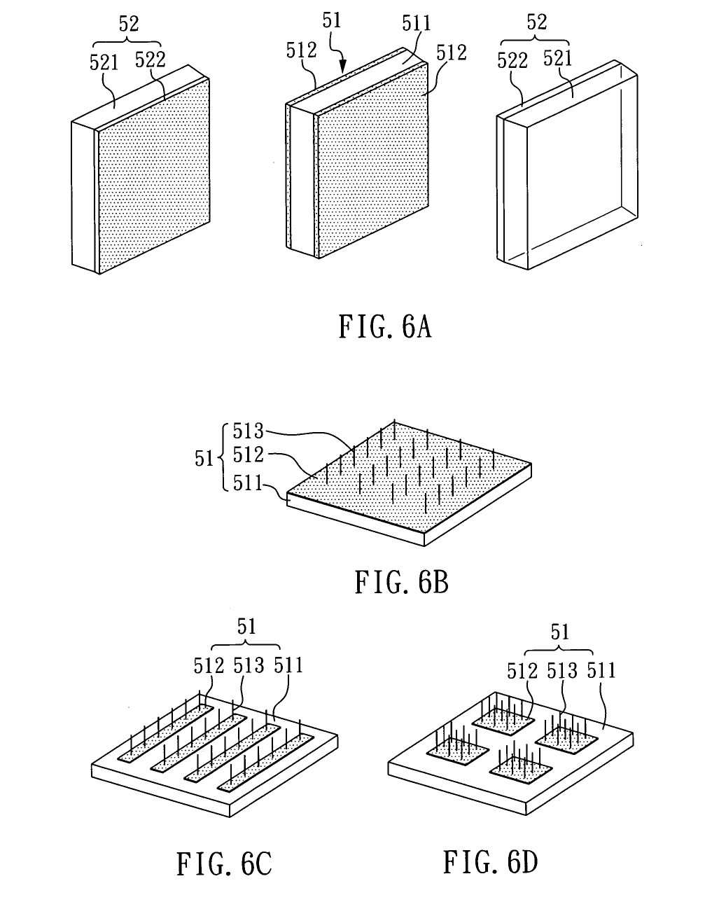

FIGS. 6A and 6B show a perspective view of the field emission lamp in the present example, and an enlarged view of its cathode, respectively. The double-sided panel field emission illuminator or light of the present example mainly contains a cathode 51 comprising a first substrate 511 (glass plate), a zinc oxide film 512 coated on the first substrate 511, and a plurality of surface-modified carbon nanomaterials 513 dispersed on the zinc oxide film 512, wherein one end of the surface-modified carbon nanomaterials 513 is adhered onto the zinc oxide film 512 (FIG. 6B); a plurality of anodes 52 comprising a second substrate 521 (glass plate), and a phosphor material layer 522 coated on the second substrate 521, wherein the phosphor material layer 522 of the anodes 52 faces the surface-modified carbon nanomaterials 513 of the cathode 51; and a spacer (not shown in the figures) disposed between the cathode 51 and the anodes 52 to maintain the gap therebetween. The field emission illuminator or light of the present example can emit blue green light having high brightness and good uniformity.

Besides, the present example also provides an aspect of a patterned cathode. With reference to FIGS. 6C and 6D, the zinc oxide film 512 and the surface-modified carbon nanotubes 513 are formed on the partial surface of the first substrate 511 so as to form a patterned cathode.

Although the present invention has been explained in relation to its preferred embodiment, it is to be understood that many other possible modifications and variations can be made without departing from the scope of the invention as hereinafter claimed.

What is claimed is:

1. A field emission device comprising:
a cathode comprising a first substrate, a zinc oxide film coated on the first substrate, and a plurality of surface-modified carbon nanomaterials dispersed on the zinc oxide film, wherein one end of the surface-modified carbon nanomaterials is adhered onto the zinc oxide film;
at least one anode comprising a second substrate, and a phosphor material layer coated on the second substrate, wherein the phosphor material layer of the anode faces the surface-modified carbon nanomaterials of the cathode; and
at least one spacer disposed between the cathode and the anode to maintain the gap therebetween.

2. The field emission device as claimed in claim 1, wherein the phosphor material layer is a zinc oxide layer.

3. A method of manufacturing a cathode emitter of a field emission device comprising:
(a) immersing a substrate in a zinc solution, and depositing a zinc-plating layer on the substrate by an electrochemical method;
(b) placing the substrate deposited with the zinc-plating layer in a chemical conversion coating bath to oxidize the zinc-plating layer into a zinc oxide film under a chemical conversion coating reaction;
(c) immersing the substrate formed with the zinc oxide film in a surface-modified carbon nanomaterial aqueous solution which provides a plurality of surface-modified carbon nanomaterials of which one end is adhered onto the zinc oxide film; and
(d) baking the zinc oxide film.

4. The method as claimed in claim 3, wherein the electrochemical method is electroplating or electroless plating.

5. The method as claimed in claim 3, wherein the zinc solution is a zinc electroplating solution or a zinc electroless plating solution.

6. The method as claimed in claim 3, wherein the surface-modified carbon nanomaterial aqueous solution comprises the plurality of carbon nanomaterials, a nonionic surfactant, an anionic surfactant, and water.

7. The method as claimed in claim 6, wherein the carbon nanomaterials are single-walled carbon nanotubes, double-walled carbon nanotubes, few-walled carbon nanotubes, multi-walled carbon nanotubes, carbon nanofibers, spiral carbon nanofibers, nanodiamonds, or the combination thereof.

8. The method as claimed in claim 3, wherein the chemical conversion coating reaction is performed at 20˜80° C. in the step (b).

9. The method as claimed in claim 3, wherein the zinc oxide film is baked at 100˜350° C. in the step (d).

10. The method as claimed in claim 3, wherein the substrate is made of metal, glass, or indium tin oxide glass.

11. The method as claimed in claim 3, wherein the field emission device is a field emission lamp, a single-sided flat field emission illuminator, or a double-sided light-emitting panel field emission illuminator.

12. A method for manufacturing a zinc oxide anode for a field emission device, comprising:
(a) immersing a substrate in a zinc solution, and depositing a zinc-plating layer on the substrate by an electrochemical method; and
(b) oxidizing the zinc-plating layer into a zinc oxide layer by thermal oxidation.

13. The method as claimed in claim 12, wherein the electrochemical method is electroplating or electroless plating.

14. The method as claimed in claim 12, wherein the zinc solution is a zinc electroplating solution or a zinc electroless plating solution.

15. The method as claimed in claim 12, wherein the substrate is made of glass, or indium tin oxide glass.

16. The method as claimed in claim 12, wherein the purity of oxygen used in the thermal oxidation is 90˜99.99%.

17. The method as claimed in claim 12, wherein the thermal oxidation is performed at 5˜100 sccm of oxygen.

18. The method as claimed in claim 12, wherein the thermal oxidation is performed at 250˜650° C.

19. The method as claimed in claim 12, wherein the field emission device is a field emission lamp, a single-sided flat field emission illuminator, or a double-sided light-emitting panel field emission illuminator.
